(19) United States
(12) Patent Application Publication
(10) Pub. No.: US 2002/0132635 A1
(43) Pub. Date: Sep. 19, 2002

(54) Method of automatically selecting a communication mode in a mobile station having at least two communication modes

(76) Inventors: Joann K. Girard, Coconut Creek, FL (US); Nicole T. Gaviria, Miami Beach, FL (US); Robert A. Marples, Sunrise, FL (US)

Correspondence Address: Scott M. Garrett, Motorola, Inc., Law Department, 8000 West Sunrise Boulevard, Fourt Lauderdale, FL, 33322, US

(21) Appl. No.: 09/811,333

(22) Filed: Mar. 16, 2001

(51) Int. Cl. H04M 1/00

(52) U.S. Cl. 455/552; 455/517; 455/566

(57) ABSTRACT

A mobile station capable of communicating in more than one mode of communication allows the user to select a desired mode of communication with a single action after deciding on the party to be called. The one-step selection process is accomplished by providing the user with features on the radio, for example, corresponding to the various modes of communication available to the user.

### TECHNICAL FIELD

This invention relates in general to mobile communications and particularly to mobile communication devices having at least two modes of communication.

### BACKGROUND OF THE INVENTION

Increasingly there are communication devices available which can communicate in several different modes. Different modes of communication include, for example, telephone calling, private dispatch, group dispatch, and Internet access mode. In addition, there is increasing demand for multimode communication devices, cellular telephones, that can communicate using more than one air interface, such as code division multiple access (CDMA), time division multiple access (TDMA), and so on. These communication devices are all capable of communicating in more than one mode of communication.

Although having more than one mode of communication is an advantage over separate communication devices for each mode of communication, it makes operating the multimode communication device more complex from a users experience. Typically the user has to select the mode of communication first by pressing, for example, a “mode” button until the user interface brings up the desired mode. Once the mode is selected, the user can either enter the number of the party to be called, or, select from a list of numbers or aliases stored in a memory of the device. Aliases have numbers associated with them or the particular call type. This creates a problem because if a party can be contacted by more than one communication mode, such as by telephone and private dispatch call (a form of simplex communication), then there is one alias and associated number in a telephone list stored in the device, and a second alias and associated number in a private call list also stored in the device. This results in multiple alias entries in the memory of the device for the same party.

As multimode communication devices become more prevalent, the need for a simple user interface becomes heightened. The ease of use of a communication device is especially relevant in the consumer market. Another aspect that tends to make operation of conventional multimode devices complex is when the user has the calling number of the party to be called, but does not have an alias entry in the memory of the communication device. In this case the user must first select the desired mode of communication, then enter the number, then press the appropriate button to initiate a call. The mode selection is typically done by depressing a mode button. Upon pushing the mode button, the user selects the next mode of communication. In a device with three or more modes, the user has to cycle through all the selection to select the desired mode, then enter the calling number, then press another button corresponding to the selected mode. Typically there are several different buttons corresponding to various modes for initiating a call, such as an off-hook button, a push-to-talk button, and so on.

In the market for communication devices, simple, easy to use man-machine interfaces are an advantage and key selling feature. Consumers prefer easy to use devices over complicated devices which require multiple operations to initiate a call. Therefore there is a need, in a communication device interface, for a simple means of selecting the desired mode of communication.

### BRIEF DESCRIPTION OF THE DRAWINGS

FIG. 1 shows a front elevational view a mobile station in for use in accordance with the invention;

FIG. 2 shows a block diagram of an alias record and associated calling number for use in a mobile station in accordance with the invention; and

FIG. 3 shows a flow chart diagram of a method for automatically selecting a communication mode in a mobile station.

### DETAILED DESCRIPTION OF A PREFERRED EMBODIMENT

While the specification concludes with claims defining the features of the invention that are regarded as novel, it is believed that the invention will be better understood from a consideration of the following description in conjunction with the drawing figures, in which like reference numerals are carried forward.

The invention solves the problem of having a complex user interface in a multimode communication device by eliminating the need for a mode button, and providing the device with decision making ability to determine what mode should be used based on the format of the calling number and the operation of the device by the user.

Referring now to FIG. 1, there is shown a front elevational view a mobile station 100 in for use in accordance with the invention. The mobile station is designed to facilitate multiple modes of communication, such as the communication device manufactured by Motorola, Inc., and sold under the trade name iDEN. These devices are capable of duplex telephone communication, private and talk group dispatch communication, and chat communication. It is also contemplated that more than one cellular telephone air interface may be used to be able to facilitate phone calls in, for example, systems in accordance with the Global Specification for Mobile communication (GSM), as well as various code division multiple access (CDMA) systems, analog cellular telephone systems, and so on. As is conventional, the device 100 comprises a display 102, first and second soft keys 104, 106, respectively, a push to talk (PTT) button 108, off-hook and on-hook buttons 110, 112, respectively, as well as the usual buttons found on mobile communication devices. The display comprises a line 114 for displaying an alias, or calling number entered by the user. A scroll button 116 permits the user to scroll through a list of aliases stored in the device's memory.

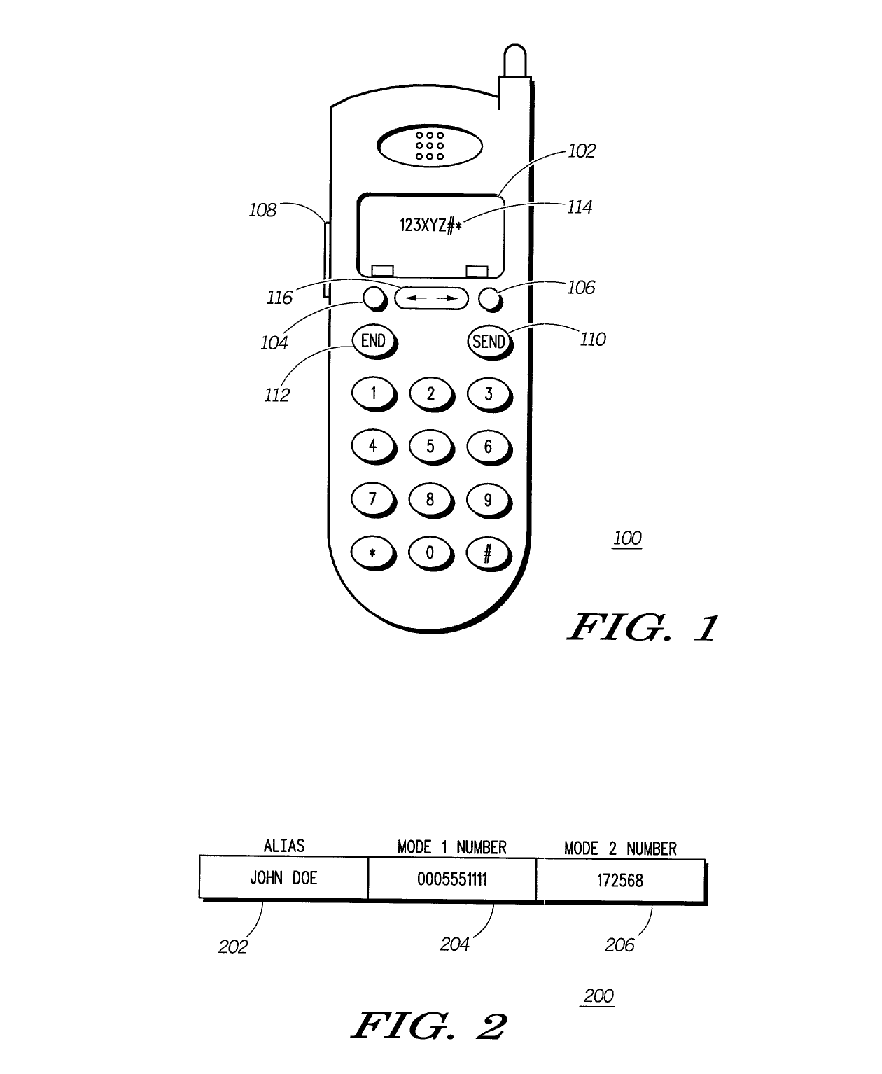

Referring now to FIG. 2, there is shown a block diagram 200 of an alias record and associated calling number for use in a mobile station in accordance with the invention. The alias record is stored in the memory of the device 100, and includes an alphanumeric field 202 for the name of the party, a first calling number corresponding with a first mode of communication, such as a phone number 204, and a second calling number corresponding with a second mode of communication, such as a private dispatch identifier 206. Additional calling numbers or calling strings can be added to the alias record to, including a chat identifier for the party, so that the user of the device can send text messages to the party. The alias record may also be a record for a talk group, and include an associated talk group identifier.

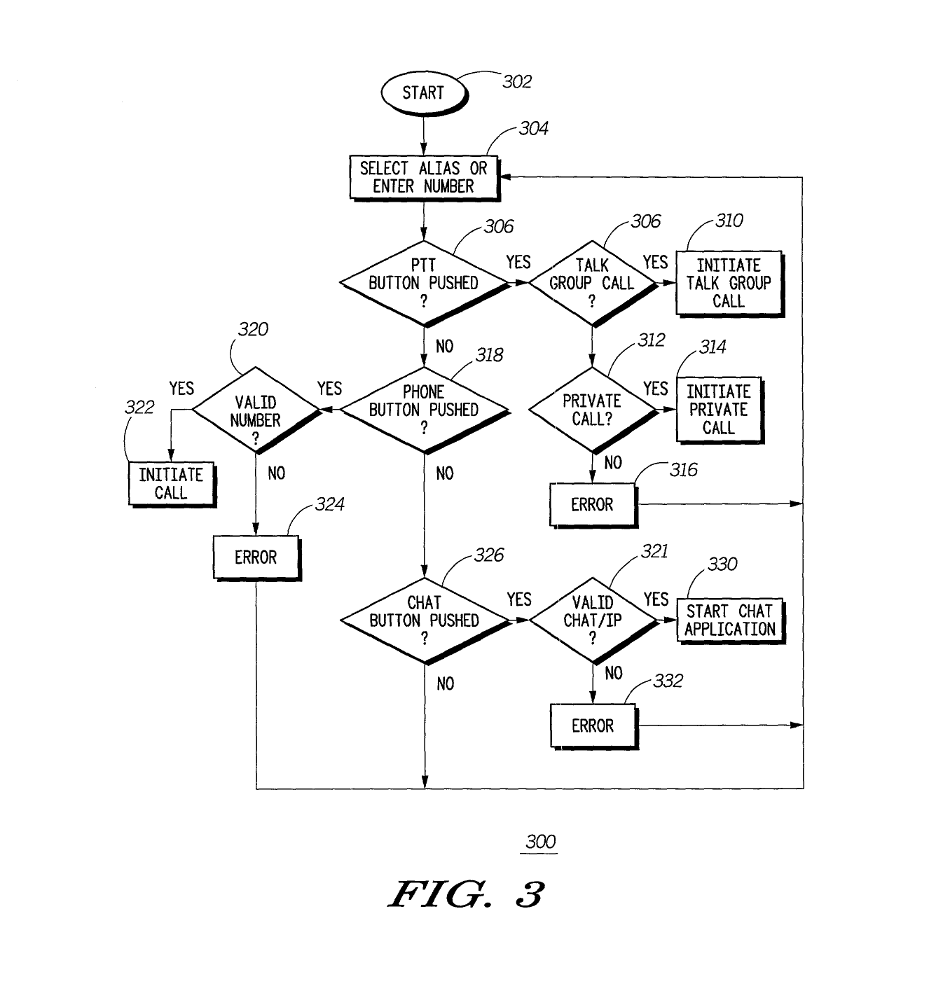

Referring now to FIG. 3, there is shown a flow chart diagram 300 of a method for automatically selecting a communication mode in a mobile station. As discussed in regard to the communication device illustrated in FIG. 1, the mobile station has at least two modes of communication. At the start 302 the device is powered up, and registered for service. The first step (304) is taken by the user, and is selecting an alias record from the memory, or entering a calling number or calling string. The device shows this on, for example, line 114 of the display 102 in FIG. 1. The next step is selecting one of modes of communication. Only one action is required by the user of the mobile station to select the desired mode of communication. This is done by, for example, pressing the PTT button, the off-hook button, or a soft key. The act of pushing a button is regard as a single action, and means that the user does not have to push multiple buttons, and a mode button several times to select the desired mode. Furthermore, it is contemplated that the device may be equipped with a voice recognition means, and can receive a single voice command to engage the desired mode of communication.

As an example, a user desiring to make a dispatch call would, for example, push the PTT button. Once the device detects the PTT button being pressed (306), the device checks to see if a talk group mode is indicated by the alias selected by the user in step 304, or if the format of the calling number or calling string entered by the user in step 304 indicates that the desired dispatch mode is a talk group call (308). If a talk group call is indicated, the mobile station commences initiating a talk group call (310). A talk group call is a one-to-many type of simplex communication where one user speaks and several other users hear the speaking user at the same time. This mode is similar to trunked two-way radio communication. The formatting of the calling string entered can indicate the desired talk group number, or if no talk group is indicated, the mobile station can simply use the number of the most recent talk group used by the user. Conventionally talk groups are defined by the operator of the communication system, although the mobile station may contain an associated list of desired talk group members, and transmit that list to the communication system to facilitate call set-up.

If a talk group call is not indicated by the alias or calling number format, then the mobile station checks to see if a private dispatch call is indicated by the PTT button push event (312). If so, then the mobile station commences a private dispatch call to another user. A private dispatch call is a simplex communication between two users, and is not heard by other users. If the mobile station determines that private dispatch call has been selected, the mobile station commences initiating a private dispatch call (314). If neither a talk group call or private call are indicated upon detecting a PTT push event, then the mobile station processes it as an error (316).

An alternative action that can be taken after selecting an alias or entering a calling number or call string in step 304 is for the user to push the off-hook button 110, which the mobile station detects (318), indicating the user desires to make a phone call. In such a case the mobile station either fetches the phone number from the alias record, or determines if the entered number is a valid phone number (320). Then the mobile station commences initiating a phone call (322). If the calling number entered by the user is not in a recognized phone number format, then appropriate error processing is invoked (324).

Another alternative mode of communication the user may desire to commence is chat communication. Chat communication is a text messaging communication where the users send text messages to other users, and vice-versa. The mobile station may comprise a dedicated chat button, or the chat application may be invoked via a soft key and a corresponding heading being displayed by the mobile station. If the chat mode is selected (326), the mobile station fetches the chat alias or internet protocol (IP) address from the alias record for the party, or, if the user entered the chat alias or IP address manually, the mobile station checks to make sure it is a valid alias or IP address (328) and commences a chat session (330). If there is a problem with the chat alias of IP address, then the mobile station commences appropriate error processing (332).

These four different modes of communication, private dispatch, talk group dispatch, phone, and chat, are by no means the only modes that can be selected. It is further contemplated that various specific air interfaces may be selected. For example, a mobile station may be equipped to communicate using GSM, CDMA, as well as time division multiple access (TDMA) cellular telephone air interfaces. This would be useful to a user who frequently travels. In such a case, the user completes step 304, either by selecting an alias record stored in the device, or enter a calling number or string, whereupon the mobile station presents the user with a soft menu of air interfaces to select from. In accordance with the invention, each of these would be selectable at the same time, so that the user only has to take a single action to select the desired mode of communication. Similarly, if the mobile station is equipped with speech recognition ability, the user simply speaks the desired mode of communication such as by speaking “GSM”, for example.

Furthermore it is specifically contemplated that when the user selects an alias record from memory, the mobile station displays all of the various modes of communication by which the alias record indicates the party maybe contacted in a soft menu with corresponding soft key buttons provided on the mobile station. So, for example, if the alias record indicates the party may be contacted by private dispatch, telephone, and chat, the mobile station displays the three modes, such as by displaying icons like “PHONE”, “PRIVATE”, and “CHAT”, or appropriate graphical symbols on the display of the device. These may be located in correspondence with associated soft keys, or they may be observed by the user, so that an appropriate voice command may be spoken and recognized by the mobile station.

By fashioning the user interface in accordance with the invention, the user interface for a mobile station capable of engaging in a variety of modes of communication is simplified. Furthermore, it makes the interface more intuitive to the user. In a conventional mobile station, the user first selects the mode of communicating, then the desired alias or calling number. If the first mode selected by the user becomes undesirable at some point, and the user wishes to change modes, but not the party to be called, with the present invention the user simply maintains the presently selected alias record and initiates an alternative mode of communication.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A method of automatically selecting a communication mode in a mobile station having at least two communication modes, comprising:
entering a calling string into the mobile station via a user interface, wherein the calling string comprises a calling number;
selecting one of the at least two communication modes as a selected mode of communication, and wherein only one action is required by a user of the mobile station to perform the selecting; and
initiating a communication session in the selected mode of communication with the calling string.

2. A method of automatically selecting a communication mode as defined in claim 1, wherein the selecting comprises selecting a private dispatch mode of communication.

3. A method of automatically selecting a communication mode as defined in claim 2, wherein the selecting comprises selecting a private dispatch mode of communication by pressing a push-to-talk button disposed on the mobile station.

4. A method of automatically selecting a communication mode as defined in claim 1, wherein the selecting comprises selecting a talk group dispatch mode of communication.

5. A method of automatically selecting a communication mode as defined in claim 4, wherein the selecting comprises selecting a talk group dispatch mode of communication by pressing a push-to-talk button disposed on the mobile station.

6. A method of automatically selecting a communication mode as defined in claim 4, wherein the selecting comprises selecting a talk group dispatch mode of communication by selecting a most recently used talk group number.

7. A method of automatically selecting a communication mode as defined in claim 1, wherein the selecting comprises selecting a chat mode of communication.

8. A method of automatically selecting a communication mode as defined in claim 7, wherein the selecting comprises selecting a chat mode of communication by pressing a chat button disposed on the mobile station.

9. A method of automatically selecting a communication mode as defined in claim 1, wherein the selecting comprises selecting a phone mode of communication.

10. A method of automatically selecting a communication mode as defined in claim 1, further comprising:
providing at least two soft keys on the mobile station;
displaying at least two icons, each of the icons corresponding with one of the soft keys, and each of the icons associated with one of the at least two modes of communication; and
wherein the step of selecting comprises pressing one of the soft keys to initiate the mode of communication presently associated with the soft key.

11. A method of automatically selecting a communication mode in a mobile station having at least two communication modes, comprising:
selecting an alias record from a database of alias records stored in the mobile station, the alias record having at least two calling numbers associated with it, each of the calling numbers corresponding to a different communication mode;
selecting one of the at least two modes of communication as a selected mode of communication, wherein only one action is required by a user of the mobile station to select any of the at least two modes of communication; and
initiating a communication session in the selected mode of communication with the calling number corresponding to the selected mode of communication.

12. A method of automatically selecting a communication mode as defined in claim 11, wherein the selecting comprises selecting a private dispatch mode of communication.

13. A method of automatically selecting a communication mode as defined in claim 12, wherein the selecting one of the at least two modes of communication comprises selecting a private dispatch mode of communication by pressing a push-to-talk button disposed on the mobile station.

14. A method of automatically selecting a communication mode as defined in claim 11, wherein the selecting one of the at least two modes of communication comprises selecting a talk group dispatch mode of communication.

15. A method of automatically selecting a communication mode as defined in claim 14, wherein the selecting one of the at least two modes of communication comprises selecting a talk group dispatch mode of communication by pressing a push-to-talk button disposed on the mobile station.

16. A method of automatically selecting a communication mode as defined in claim 14, wherein the selecting one of the at least two modes of communication comprises selecting a talk group dispatch mode of communication by selecting a most recently used talk group number.

17. A method of automatically selecting a communication mode as defined in claim 11, wherein the selecting one of the at least two modes of communication comprises selecting a chat mode of communication.

18. A method of automatically selecting a communication mode as defined in claim 17, wherein the selecting one of the at least two modes of communication comprises selecting a chat mode of communication by pressing a chat button disposed on the mobile station.

19. A method of automatically selecting a communication mode as defined in claim 11, wherein the selecting one of the at least two modes of communication comprises selecting a phone mode of communication.

20. A method of automatically selecting a communication mode as defined in claim 11, further comprising:
providing at least two soft keys on the mobile station;
displaying at least two icons, each of the icons corresponding with one of the soft keys, and each of the icons associated with one of the at least two modes of communication; and
wherein the step of selecting one of the at least two modes of communication comprises pressing one of the soft keys to initiate the mode of communication presently associated with the soft key.
